(19) United States
(12) Patent Application Publication
(10) Pub. No.: US 2024/0376274 A1
(43) Pub. Date: Nov. 14, 2024

(54) METHOD FOR PRODUCING LIQUID CRYSTAL POLYMER PARTICLE

(71) Applicant: ENEOS Corporation, Tokyo (JP)

(72) Inventors: Kenji ONO, Tokyo (JP); Kunihiko IBAYASHI, Tokyo (JP); Hiroto FUKUDA, Tokyo (JP)

(73) Assignee: ENEOS Corporation, Tokyo (JP)

(21) Appl. No.: 18/554,109

(22) PCT Filed: Mar. 30, 2022
(86) PCT No.: PCT/JP2022/015809

§ 371 Date: Oct. 5, 2023

(30) Foreign Application Priority Data
Apr. 8, 2021 (JP) 2021-065989

(51) Int. Cl. C08J 3/12

(52) U.S. Cl. CPC C08J 3/12; C08J 2300/12

(57) ABSTRACT

To provide a method for producing a liquid crystal polymer particle, which can allow for control of a particle size distribution in a small particle size region. The method for producing a liquid crystal polymer particle according to the present invention comprises a step of pulversizing a liquid crystal polymer with a jet mill to thereby obtain a liquid crystal polymer particle in which cumulative distribution 50% size D50 is 7.0 μm or less and 95% size D95 is 15.0 μm or less in a particle size distribution.

### BACKGROUND OF THE INVENTION

### Field of the Invention

The present invention relates to a method for producing a liquid crystal polymer particle.

### Background Art

Liquid crystal polymers are excellent in dimension stability, heat resistance, chemical stability, and the like, and thus are studied to be applied in insulating resin compositions constituting electrical and electronic parts of electronic circuit boards and the like. However, liquid crystal polymers are generally low in melt tension and poor in productivity of film formation, and thus a problem is that films made of liquid crystal polymers are expensive.

In order to utilize liquid crystal polymers in additives for resin molded articles, liquid crystal polymers have been studied to be formed into fine particles. For example, Patent Literature 1 describes a modified liquid crystal polyester particle which is obtained by forming an amorphous particle made of liquid crystal polyester into a sphere and which has a volume average particle size of 7.9 μm. Patent Literature 2 describes a liquid crystal polyester powder having a volume average particle size of 8.9 μm. Patent Literature 3 discloses a liquid crystal polyester powder having an average particle size of 8 to 15 μm.

### CITATION LIST

### Patent Literature

[Patent Literature 1] JP 5396764 B
[Patent Literature 2] JP 2011-6629 A
[Patent Literature 3] JP 2020-132849 A

### SUMMARY OF THE INVENTION

### Technical Problem

However, all Patent Literature 1 to 3 cannot realize any control of particle size distributions in smaller particle size regions of polymer particles. Accordingly, an object of the present invention is to provide a method for producing a polymer particle, which can allow for control of a particle size distribution in a small particle size region.

### Solution to Problem

The present inventors have made intensive studies in order to solve the above problems, and as a result, have found that a liquid crystal polymer particle is obtained in which a liquid crystal polymer is pulversized with a jet mill and then cumulative distribution 50% size D₅₀ and 95% size D₉₅ in a particle size distribution are respectively controlled to 7.0 μm or less and 15.0 μm or less, leading to completion of the present invention. The present invention has been completed based on such findings.

Specifically, one aspect of the present invention provides
a method for producing a liquid crystal polymer particle, comprising a step of pulversizing a liquid crystal polymer with a jet mill to thereby obtain a liquid crystal polymer particle in which cumulative distribution 50% size D₅₀ is 7.0 μm or less and 95% size D₉₅ is 15.0 μm or less in a particle size distribution.

In an aspect of the present invention, a ratio of a mode size Dₚ to D₅₀ in the particle size distribution of the liquid crystal polymer particle is preferably 0.7 or more and 1.3 or less.

In an aspect of the present invention, the pulversizing is preferably performed by collision to a collision member in air flow.

In an aspect of the present invention, the method preferably further comprises a step of classifying the liquid crystal polymer particle before or after the pulversizing.

In an aspect of the present invention, the liquid crystal polymer particle preferably contains a hydroxycarboxylic acid-derived constituent unit (I), a diol compound-derived constituent unit (II), and a dicarboxylic acid-derived constituent unit (III).

In an aspect of the present invention, the hydroxycarboxylic acid-derived constituent unit (I) is preferably a 6-hydroxy-2-naphthoic acid-derived constituent unit.

In an aspect of the present invention, a compositional ratio of the constituent unit (I) based on the total constituent unit of the liquid crystal polymer particle is preferably 40% by mol or more and 80% by mol or less.

### Advantageous Effects of Invention

The method for producing a liquid crystal polymer particle of the present invention can allow for control of a particle size distribution in a small particle size region. Furthermore, the method for producing a liquid crystal polymer particle of the present invention is excellent in continuous productivity and economic performance, and thus can reduce the production cost of a liquid crystal polymer particle.

### DETAILED DESCRIPTION OF THE INVENTION

### [Method for Producing Liquid Crystal Polymer Particle]

The method for producing a liquid crystal polymer particle according to the present invention includes a pulversizing step, and preferably further includes a classification step. The classification step may be performed before the pulversizing step, or may be performed after the pulversizing step. The pulversizing step and the classification step may be sequentially repeatedly performed. The method for producing a liquid crystal polymer particle according to the present invention is excellent in continuous productivity and economic performance, and thus can reduce the production cost of a liquid crystal polymer particle.

The pulversizing step includes a step of pulversizing a liquid crystal polymer with a jet mill to thereby obtain a liquid crystal polymer in which cumulative distribution 50% size D₅₀ and 95% size D₉₅ in a particle size distribution are in respectively specified ranges. The liquid crystal polymer used in the pulversizing step may be a liquid crystal polymer powder roughly pulversized in advance to an average particle size of preferably about 50 to 500 μm, more preferably about 60 to 300 μm. The pulversizing apparatus of the liquid crystal polymer particle, here used, is preferably an apparatus for pulversizing by collision to a collision member in air flow. Such collision can allow for control of a particle size distribution in a smaller particle size region.

The classification step may be a step of classifying a liquid crystal polymer powder roughly pulversized in advance before the pulversizing step, or may be a step of classifying the liquid crystal polymer particle after the pulversizing step. The classification step can classify the liquid crystal polymer particle to thereby control a particle size distribution in a smaller particle size region. The classification apparatus of the liquid crystal polymer particle may be incorporated in a pulversizing apparatus or may be separately provided.

One example of the pulversizing apparatus for use in the production of the liquid crystal polymer particle according to the present invention is described. The pulversizing apparatus here used can be a pulversizing apparatus which includes a diffuser section for ejection of a compressed gas as a high-speed (for example, supersonic speed) continuous jet and a collision member placed downstream of the diffuser section in a main body of the pulversizing apparatus and which is for pulversizing a pulversizing object due to collision obtained by feeding the pulversizing object to the continuous jet to thereby allow the pulversizing object, together with the continuous jet, to collide to a collision member, in which the diffuser section includes a compressed gas passage for allowing the compressed gas to flow from upstream toward downstream, and an accelerating member for accelerating the compressed gas to a high speed (for example, supersonic speed), the accelerating member is placed concentrically with the compressed gas passage with an annular insertion clearance into which the compressed gas is to be inserted being interposed between the accelerating member and a periphery wall surface of the compressed gas passage, the diffuser section further includes a throat section which is located in the middle of the compressed gas passage and which is an annular clearance narrower in distance between the periphery wall surface of the compressed gas passage and an outer periphery of the accelerating member, than the insertion clearance located upstream, the accelerating member includes an accelerating conical section at the downstream section thereof, an outer periphery of the accelerating conical section is an accelerating conical surface sequentially contracted in diameter from an downstream end of the throat section toward downstream thereof, and the accelerating member is placed in the compressed gas passage so that the accelerating conical surface is partially or fully positioned with a downstream tip of the accelerating conical surface being leveled with or located downstream against an exit of the compressed gas passage.

The pulversizing apparatus including the above configuration may include a built-in classifier. The pulversizing object inserted into the built-in classifier is classified to a coarse powder and a fine powder by centrifugation. A fine powder pulversized so as to have a predetermined particle size is taken outside the pulversizing apparatus. On the other hand, a coarse powder not pulversized so as to have a predetermined particle size is preferably sent to the pulversizing apparatus and then pulversized. The classifier may be provided separately from the pulversizing apparatus. The classifier and the pulversizing apparatus may be disposed separately in a predetermined identical plant so that the pulversizing object classified by the classifier can be fed to the pulversizing apparatus and pulversized into a fine powder. Alternatively, the classifier and the pulversizing apparatus can also be each used singly without being combined.

The pulversizing/classification apparatus for use in the production of a liquid crystal polymer particle according to the present invention can also be a commercially available apparatus. For example, a pulversizing apparatus described in JP 2017-70903 A can be used.

### [Liquid Crystal Polymer Particle]

A liquid crystal polymer particle obtained by the production method of the present invention is a fine particle which is obtained with a liquid crystal polymer as a raw material and which has a specified particle size distribution. In the present invention, the particle size distribution of the liquid crystal polymer particle can be measured with a particle size distribution measurement apparatus by a laser diffraction/scattering method. In the particle size distribution, the cumulative distribution 50% size D₅₀ (hereinafter, referred to as “D₅₀”) represents a particle size where the cumulative distribution from the small particle size side reaches 50% and the cumulative distribution 95% size D₉₅ (hereinafter, referred to as “D₉₅”) represents a particle size where the cumulative distribution from the small particle size side reaches 90%, and the mode size Dₚ (hereinafter, referred to as “Dₚ”) represents a value of the particle size of the highest frequency.

D₅₀ and D₉₅ in the particle size distribution of the liquid crystal polymer particle are respectively 7.0 μm or less and 15.0 μm or less.

D₅₀ is preferably 0.1 μm or more, more preferably 1.0 μm or more, further preferably 2.0 μm or more, and preferably 6.0 μm or less, more preferably 5.0 μm or less.

D₉₅ is preferably 1.0 μm or more, more preferably 3.0 μm or more, further preferably 5.0 μm or more, and preferably 12.0 μm or less, more preferably 10.0 μm or less.

D₉₅ is preferably 2.2 times or less, more preferably 2.0 times or less, further preferably 1.8 times or less, and 1.1 times or more, relative to D₅₀.

The values of D₅₀ and D₉₅ as parameters in the particle size distribution of the liquid crystal polymer particle can be modulated in the above ranges, to result in a reduction in dielectric tangent in the case of addition to a resin molded article. The values of D₅₀ and D₉₅ can be modulated by the pulversizing method/pulversizing conditions of the liquid crystal polymer, the classification method/classification conditions before or after the pulversizing, and the like.

The ratio of Dₚ to D₅₀ in the particle size distribution of the liquid crystal polymer particle is preferably 0.7 or more and 1.3 or less, and is more preferably 0.75 times or more and 1.25 times or less, more preferably 0.8 times or more and 1.2 times or less. The ratio of Dₚ to D₅₀ can be modulated in the range, to result in a reduction in dielectric tangent in the case of addition to a resin film. The value of Dₚ can be modulated by the pulversizing method/pulversizing conditions of the liquid crystal polymer particle, the classification method/classification conditions before or after the pulversizing, and the like, as in the values of D₅₀ and D₉₅.

The crystallinity of the liquid crystal polymer particle can be confirmed by using a polarization microscope (trade name: BH-2) manufactured by OLYMPUS CORPORATION, provided with a hot stage (trade name: FP82HT) for microscopes, manufactured by METTLER TOLEDO, and heating and melting the liquid crystal polymer particle on such a heating stage for microscopes and then observing the presence of optical anisotropy.

### [Liquid Crystal Polymer]

The composition of the liquid crystal polymer as a raw material of the liquid crystal polymer particle obtained by the production method of the present invention is not particularly limited, and preferably contains an aromatic hydroxycarboxylic acid-derived constituent unit (I), an aromatic diol compound-derived constituent unit (II), and an aromatic dicarboxylic acid-derived constituent unit (III). The liquid crystal polymer in the present invention may further contain a constituent unit (IV) as a constituent unit other than the constituent units (I) to (III). Hereinafter, each constituent unit contained in the liquid crystal polymer is described.

### (Hydroxycarboxylic Acid-Derived Constituent Unit (I))

The unit (I) constituting the liquid crystal polymer is a hydroxycarboxylic acid-derived constituent unit, and is preferably an aromatic hydroxycarboxylic acid-derived constituent unit represented by the following formula (I). The constituent unit (I) may be contained singly or in combination of two or more kinds thereof.

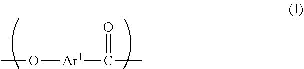

In the formula, Ar¹ is selected from the group consisting of a phenyl group, a biphenyl group, a 4,4′-isopropylidenediphenyl group, a naphthyl group, an anthryl group, and a phenanthryl group each optionally having a substituent. In particular, a naphthyl group is preferable. Examples of the substituent include hydrogen, an alkyl group, an alkoxy group, and fluorine. The number of carbon atoms in the alkyl group is preferably 1 to 10, more preferably 1 to 5. The alkyl group may be a linear alkyl group or a branched alkyl group. The number of carbon atoms in the alkoxy group is preferably 1 to 10, more preferably 1 to 5.

Examples of the monomer imparting the constituent unit represented by formula (I) include 6-hydroxy-2-naphthoic acid (HNA, the following formula (1)), and acylated products, ester derivatives and acid halides thereof.

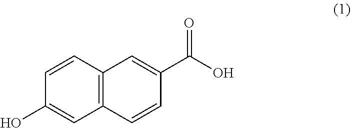 [SMILES: O=C(O)c1ccc2cc(O)ccc2c1]

The lower limit value of the compositional ratio (% by mol) of the constituent unit (I) to the constituent units of the entire liquid crystal polymer is preferably 40% by mol or more, more preferably 45% by mol or more, further preferably 50% by mol or more, still more preferably 55% by mol or more, and the upper limit value thereof is preferably 80% by mol or less, more preferably 75% by mol or less, further preferably 70% by mol or less, still more preferably 65% by mol or less. When two or more of the constituent units (I) are contained, the total molar ratio thereof may be in the compositional ratio.

### (Diol Compound-Derived Constituent Unit (II))

The unit (II) constituting the liquid crystal polymer is a diol compound-derived constituent unit, and is preferably an aromatic diol compound-derived constituent unit represented by the following formula (II). The constituent unit (II) may be contained singly or in combination of two or more kinds thereof.

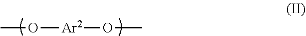

In the formula, Ar² is selected from the group consisting of a phenyl group, a biphenyl group, a 4,4′-isopropylidenediphenyl group, a naphthyl group, an anthryl group, and a phenanthryl group each optionally having a substituent. In particular, a phenyl group and a biphenyl group are preferable. Examples of the substituent include hydrogen, an alkyl group, an alkoxy group, and fluorine. The number of carbon atoms in the alkyl group is preferably 1 to 10, more preferably 1 to 5. The alkyl group may be a linear alkyl group or a branched alkyl group. The number of carbon atoms in the alkoxy group is preferably 1 to 10, more preferably 1 to 5.

Examples of the monomer imparting the constituent unit (II) include 4,4-dihydroxybiphenyl (BP, the following formula (2)), hydroquinone (HQ, the following formula (3)), methylhydroquinone (MeHQ, the following formula (4)), 4,4′-isopropylidene diphenol (BisPA, the following formula (5)), and acylated products, ester derivatives and acid halides thereof. In particular, 4,4-dihydroxybiphenyl (BP), and acylated products, ester derivatives and acid halides thereof are preferably used.

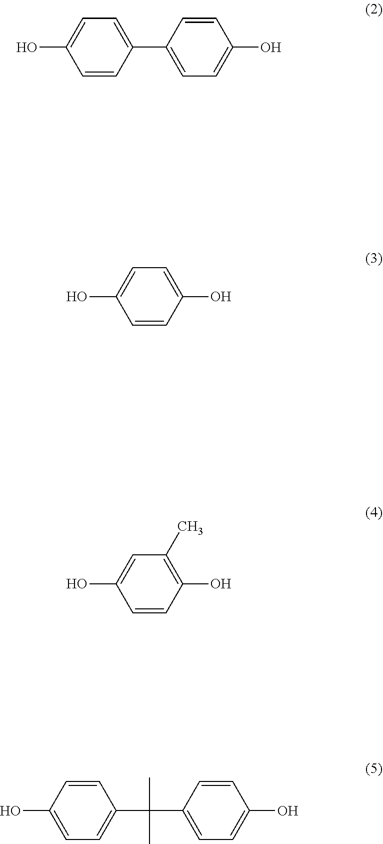

The lower limit value of the compositional ratio (% by mol) of the constituent unit (II) to the constituent units of the entire liquid crystal polymer is preferably 10% by mol or more, more preferably 12.5% by mol or more, further preferably 15% by mol or more, still more preferably 17.5% by mol or more, and the upper limit value thereof is preferably 30% by mol or less, more preferably 27.5% by mol or less, further preferably 25% by mol or less, still more preferably 22.5% by mol or less. When two or more of the constituent units (II) are contained, the total molar ratio thereof may be in the compositional ratio.

### (Aromatic Dicarboxylic Acid-Derived Constituent Unit (III))

The unit (III) constituting the liquid crystal polymer is a dicarboxylic acid-derived constituent unit, and is preferably an aromatic dicarboxylic acid-derived constituent unit represented by the following formula (III). The constituent unit (III) may be contained singly or in combination of two or more kinds thereof.

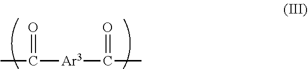

In the formula, Ar³ is selected from the group consisting of a phenyl group, a biphenyl group, a 4,4′-isopropylidenediphenyl group, a naphthyl group, an anthryl group, and a phenanthryl group each optionally having a substituent. In particular, a phenyl group and a naphthyl group are preferable. Examples of the substituent include hydrogen, an alkyl group, an alkoxy group, and fluorine. The number of carbon atoms in the alkyl group is preferably 1 to 10, more preferably 1 to 5. The alkyl group may be a linear alkyl group or a branched alkyl group. The number of carbon atoms in the alkoxy group is preferably 1 to 10, more preferably 1 to 5.

Examples of the monomer imparting the constituent unit (III) include terephthalic acid (TPA, the following formula (6)), isophthalic acid (IPA, the following formula (7)), 2,6-naphthalenedicarboxylic acid (NADA, the following formula (8)), and acylated products, ester derivatives and acid halides thereof.

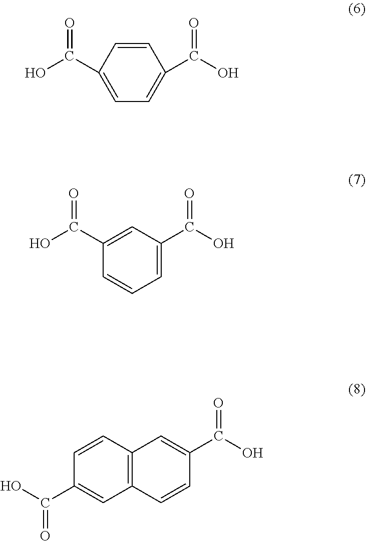 [SMILES: O=C(O)c1ccc(C(=O)O)cc1 ; O=C(O)c1cccc(C(=O)O)c1 ; O=C(O)c1ccc2cc(C(=O)O)ccc2c1]

The lower limit value of the compositional ratio (% by mol) of the constituent unit (III) to the constituent units of the entire liquid crystal polymer is preferably 10% by mol or more, more preferably 12.5% by mol or more, further preferably 15% by mol or more, still more preferably 17.5% by mol or more, and the upper limit value thereof is preferably 30% by mol or less, more preferably 27.5% by mol or less, further preferably 25% by mol or less, still more preferably 22.5% by mol or less. When two or more of the constituent units (II) are contained, the total molar ratio thereof may be in the compositional ratio. The compositional ratio of the constituent unit (II) and the compositional ratio of the constituent unit (III) are substantially equivalent ((constituent unit (II) ≈constituent unit (III)).

### (Other Monomer-Derived Constituent Unit (IV))

The liquid crystal polymer may contain any constituent unit other than the constituent units (I) to (III). The constituent unit (IV) is not particularly limited as long as it is derived from any monomer other than the monomers respectively imparting the constituent units (I) to (III) and derived from a monomer having polymerizing ability so as to be polymerizable with the monomers respectively imparting the constituent units (I) to (III). Examples of the polymerizable group include a hydroxy group, a carboxyl group, an amine group, and an amide group. The monomer imparting the constituent unit (IV) has one or more, preferably two or more such polymerizable groups. When two or more such polymerizable groups are contained, such polymerizable groups may be the same as or different from each other. The constituent unit (IV) may be contained singly or in combination of two or more kinds thereof.

Examples of the constituent unit (IV) include the following constituent unit (IV-1).

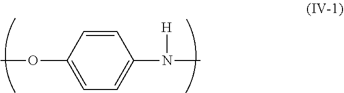

Examples of the monomer imparting the constituent unit (IV-1) include acetoaminophene (AAP, the following formula (9)), p-aminophenol, 4′-acetoxyacetanilide, and acylated products, ester derivatives, and acid halides thereof.

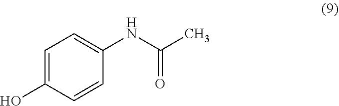

Examples of the constituent unit (IV) include the following constituent unit (IV-2).

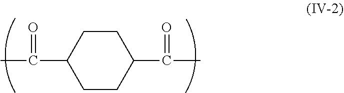

Examples of the monomer imparting the constituent unit (V-2) include 1,4-cyclohexanedicarboxylic acid (CHDA, the following formula (10)), and acylated products, ester derivatives and acid halides thereof.

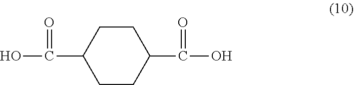 [SMILES: O=C(O)C1CCC(C(=O)O)CC1]

The compositional ratio (% by mol) of the constituent unit (IV) to the constituent units of the entire liquid crystal polymer can be appropriately set depending on the compositional ratios of the constituent units (I) to (III). Specifically, the compositional ratio of each of the constituent units may be appropriately set so that the monomer ratio (molar ratio) between a carboxyl group and a hydroxy group and/or an amine group in monomer loading is in the range of about 1:1.

The liquid crystal polymer is particularly preferably compounded so that at least the ratio of the constituent unit of 6-hydroxy-2-naphthoic acid to the constituent units of the entire liquid crystal polymer is in the range of 45% by mol or more and 75% by mol or less. The liquid crystal polymer is extremely preferably compounded so that the followings are satisfied:

$$45 \% by mol \leq 6 - hydroxy - 2 - naphthoic acid - derived constituent unit ( I ) \leq 75 \% by mol$$

$$12 \% by mol \leq aromatic diol compound - derived constituent unit ( II ) \leq 27.5 \% by mol$$

$$3 \% by mol \leq terephthalic acid - derived constituent unit ( III ) \leq 25 \% by mol$$

$$2 \% by mol \leq$$

$$2 , 6 - naphthalenedicarboxylic acid - derived constituent unit ( III ) \leq$$

$$9 \% by mol .$$

When the ratio of each of the constituent units to the constituent units of the entire liquid crystal polymer is in the above range, a liquid crystal polymer low in dielectric tangent can be obtained.

The lower limit value of the melt viscosity of the liquid crystal polymer is preferably 5 Pas or more, more preferably 10 Pa·s or more, further preferably 15 Pa·s or more, and the upper limit value thereof is preferably 200 Pas or less, more preferably 150 Pa·s, further preferably 100 Pa·s or less, in conditions of +20° C. or more above the melting point of liquid crystal polymer and a shear speed of 1000 s⁻¹, from the viewpoint of processability of the liquid crystal polymer particle.

(Method for producing liquid crystal polymer)

The liquid crystal polymer can be produced by polymerizing optionally the monomers respectively imparting the constituent units (I) to (III) and optionally the monomer imparting the constituent unit (IV) by a conventionally known method. In one embodiment, the liquid crystal polymer according to the present invention can also be produced by two-step polymerization of production of a prepolymer by melt polymerization and furthermore solid phase polymerization of the prepolymer.

The melt polymerization is preferably performed with 100% by mol in total of optionally the monomers respectively imparting the constituent units (I) to (III) and optionally the monomer imparting the constituent unit (IV) combined by predetermined compounding, under acetic acid reflux in the presence of 1.05 to 1.15 molar equivalents of acetic anhydride relative to all the hydroxyl groups contained in the monomers, from the viewpoint that the liquid crystal polymer according to the present invention is efficiently obtained.

When the polymerization reaction is performed at two steps of the melt polymerization and the subsequent solid phase polymerization, for example, a method is preferably selected in which a prepolymer obtained by the melt polymerization is cooled and solidified and then pulversized into a powder or flake, and then such a prepolymer resin is heat-treated by a known solid phase polymerization method, for example, under an inert atmosphere of nitrogen or the like or under vacuum in a temperature range from 200 to 350° C. for 1 to 30 hours. The solid phase polymerization may be performed with stirring or may be performed with being left to stand without stirring.

A catalyst may or may not be used in the polymerization reaction. The catalyst here used can be one conventionally known as a catalyst for formation of a polyester by polymerization, and examples thereof include metal salt catalysts such as magnesium acetate, stannous acetate, tetrabutyl titanate, lead acetate, sodium acetate, potassium acetate and antimony trioxide, nitrogen-containing heterocyclic compounds such as N-methylimidazole, and organic compound catalysts. The amount of the catalyst used is not particularly limited, and is preferably 0.0001 to 0.1 parts by weight based on 100 parts by weight of the total amount of the monomers.

The polymerization reaction apparatus in the melt polymerization is not particularly limited, and a reaction apparatus used in common high-viscosity fluid reaction is preferably used. Examples of such a reaction apparatus include a stirring tank-type polymerization reaction apparatus including a stirring apparatus having an anchor-type, multistage-type, spiral belt-type, spiral axis-type, or its modified stirring blade, or a mixing apparatus commonly used in the kneading of a resin, such as a kneader, a roll mill, or a Bunbury mixer.

### [Application]

The liquid crystal polymer particle obtained by the production method of the present invention can be used as an additive of a resin composition. The liquid crystal polymer particle is low in dielectric tangent, and can be added to a resin composition to thereby reduce the dielectric tangent of a molded article made of the resin composition. Thus, the liquid crystal polymer particle can be suitably used in an insulating resin molded article constituting electrical and electronic parts for electronic circuit boards and the like.

### EXAMPLES

Hereinafter, the present invention is more specifically described with reference to Examples, but the present invention is not limited to such Examples.

### <Synthesis of Liquid Crystal Polymer>

### Synthesis Example 1

To a polymerization container having a stirring blade, 60% by mol of 6-hydroxy-2-naphthoic acid (HNA), 20% by mol of 4,4-dihydroxybiphenyl (BP), 15.5% by mol of terephthalic acid (TPA), and 4.5% by mol of 2,6-naphthalenedicarboxylic acid (NADA) were added, potassium acetate and magnesium acetate were loaded thereto as catalysts, purging with nitrogen was performed by depressurizing of the polymerization container and nitrogen injection three times, thereafter acetic anhydride (1.08 molar equivalents relative to hydrogen group) was further added, and the resultant was heated to 150° C. and subjected to acetylation reaction in a reflex state for 2 hours.

After completion of acetylation, the polymerization container where acetic acid was distilled off was subjected to temperature rise at 0.5° C./min, a polymerized product was extracted after the temperature of a melt in the tank reached 310° C., and then cooled and solidified. The polymerized product obtained was pulversized to a size so as to pass through an aperture of 2.0 mm, and thus a prepolymer was obtained.

Next, the prepolymer obtained was heated in a heater of an oven manufactured by Yamato Scientific Co., Ltd., from room temperature to 295° C. over 14 hours, and thereafter the temperature was retained at 295° C. for 1 hour, to thereby perform solid phase polymerization. Thereafter, the prepolymer was subjected to natural heat radiation at room temperature, and thus a liquid crystal polymer A was obtained. A polarization microscope (trade name: BH-2) manufactured by OLYMPUS CORPORATION, provided with a hot stage (trade name: FP82HT) for microscopes, manufactured by METTLER TOLEDO, was used to melt and heat the liquid crystal polymer A on such a heating stage for microscopes, and it was then confirmed based on the presence of optical anisotropy that crystallinity was exhibited.

### Synthesis Example 2

A liquid crystal polymer B was obtained in the same manner as in Synthesis Example 1 except that polymerization conditions were changed. The crystallinity exhibited by the liquid crystal polymer B was confirmed in the same manner as in Synthesis Example 1.

### (Measurement of Melting Point)

The melting point of each of the liquid crystal polymers A and B obtained above was measured with a differential scanning calorimeter (DSC) manufactured by Hitachi High-Tech Science Corporation, according to a test method of ISO11357, ASTM D3418. After the temperature was here raised from room temperature to 360 to 380° C. at a rate of temperature rise of 10° C./min to completely melt each of the polymers, the temperature was dropped to 30° C. at a rate of 10° C./min and furthermore raised to 380° C. at a rate of 10° C./min and the endothermic peak top here obtained was defined as the melting point (Tm₂). The measurement results were shown in Table 1.

### (Measurement of Melt Viscosity)

The melt viscosity of each of the liquid crystal polymers A and B synthesized above was determined by measuring the melt viscosity (Pa·s) at +20° C. above the melting point at a shear speed of 1000 s⁻¹, with a capillary rheometer viscometer (CAPIROGRAPH 1D manufactured by Toyo Seiki Seisaku-sho, Ltd.) and a capillary having an inner diameter of 1 mm, according to JIS K7199. The measurement results were shown in Table 1.

### (Measurement of Molecular Weight and Molecular Weight Distribution)

The weight average molecular weights (Mw), number average molecular weights (Mn), and molecular weight distributions (Mw/Mn) of the liquid crystal polymers A and B synthesized above were measured with gel permeation chromatography (GPC). The measurement results were shown in Table 1.

TABLE 1

| Liquid | Melting | Melt | | | |
|---|---|---|---|---|---|
| crystal | point | viscosity | | | |
| polymer | (° C.) | (Pa · s) | Mw | Mn | Mw/Mn |
| A | 320 | 93 | 479000 | 245000 | 1.96 |
| B | 320 | 16 | 199000 | 109000 | 1.83 |

### <Production of Liquid Crystal Polymer Particle>

### Example 1

The powder (average size 80 μm) of the liquid crystal polymer A synthesized above was pulversized with a collision plate type supersonic jet mill (built-in classifier (adjusting ring: 70 mm, center navel: @60 mm, blower setting: −45 kPa), manufactured by Nippon Pneumatic Mfg. Co., Ltd., model number: SPK-12+UFS10) in conditions of a pulversizing pressure of 0.65 MPa and 4.35 kg/h. As a result, a substantially spherical liquid crystal polymer particle was obtained.

### Examples 2 to 8

Each substantially spherical liquid crystal polymer particle was obtained by pulversizing in the same manner as in Example 1 except that the type and production process of the liquid crystal polymer were changed as described in Table 2.

### Example 9

The powder (average size 80 μm) of the liquid crystal polymer B synthesized above was pulversized with a collision plate type supersonic jet mill (built-in classifier (adjusting ring: 70 mm, center navel: ¢60 mm, blower setting: −45 kPa), manufactured by Nippon Pneumatic Mfg. Co., Ltd., model number: SPK-12+UFS10) in conditions of a pulversizing pressure of 0.65 MPa and 10 kg/h. Thereafter, the liquid crystal polymer particle pulversized was further classified with a classifier (height of adjusting ring: 30 mm, height of distance ring: 15 mm, guide vane gap: 4 mm, diameter of center navel: ϕ40 mm, louver opening: 1 mm, manufactured by Nippon Pneumatic Mfg. Co., Ltd., model number: DXF2), and thus a substantially spherical liquid crystal polymer particle was obtained.

### Examples 10 to 11

Each substantially spherical liquid crystal polymer particle was obtained by pulversizing in the same manner as in Example 9 except that the type and production conditions of the liquid crystal polymer particle were changed as described in Table 2.

### Comparative Example 1

The powder (average size 80 μm) of the liquid crystal polymer A synthesized above was pulversized with a collision type fine grinder (built-in classifier (rotor shape: number of rotations of long-blade rotor: 7000 rpm, blower setting: −15 kPa), manufactured by Hosokawa Micron, model number: ACM pulverizer-15H) in conditions of the number of rotations of 7800 rpm and a feeding speed of 26 kg/h. As a result, a substantially spherical liquid crystal polymer particle was obtained.

### Comparative Example 2

A substantially spherical liquid crystal polymer particle was obtained by pulversizing in the same manner as in Comparative Example 1 except that production conditions of the liquid crystal polymer particle were changed as described in Table 2.

### Comparative Example 3

The powder (average size 80 μm) of the liquid crystal polymer A synthesized above was pulversized with a high cooling type mechanical fine grinder (manufactured by Hosokawa Micron, model number: Glacis GC-15H) in conditions of the number of rotations of 8000 rpm and a feeding speed of 10 kg/h. As a result, a substantially spherical liquid crystal polymer particle was obtained.

### Comparative Example 4

The powder (average size 80 μm) of the liquid crystal polymer A synthesized above was tried to be pulversized with a wet fine grinder (ball mill type, manufactured by Ashizawa Finetech Ltd., model number: LMZ2), but could not be pulversized.

### Comparative Example 5

The powder (average size 80 μm) of the liquid crystal polymer A synthesized above was tried to be pulversized with a wet pulverization and dispersion device (manufactured by Sugino Machine Limited, model number: STAR BURST 5.5 kw), but could not be pulversized.

### <Evaluation of Liquid Crystal Polymer Particle>

### (Measurement of Particle Size Distribution)

A particle size distribution of each of the liquid crystal polymer particles obtained above was measured with a particle size distribution measurement apparatus by a laser diffraction/scattering method (manufactured by Beckman Coulter, Inc., LS 13 320 dry system, Tornado dry powder module attached). D₅₀, D₉₅ and Dₚ as parameters representing a particle size distribution were obtained as computed results from the measurement data. The results were shown in Table 2.

TABLE 2

| | | Production process | | | | | | | | | |
|---|---|---|---|---|---|---|---|---|---|---|---|
| | | | | | Pulversizing | | | | | | |
| | | | Built-in | Dedicated | conditions | | Particle size distribution | | | | |
| | Liquid | | classifier | classifier | Pulversizing | Feeding | | | | D₉₅/ | |
| | crystal | Pulversizing | Classification | Classification | pressure | speed | D₅₀ | D₉₅ | Dₚ | D₅₀ | Dp/ |
| | polymer | method | system | system | (MPa) | (kg/h) | (μm) | (μm) | (μm) | (μm) | D₅₀ |
| Example 1 | A | Collision | Air flow | No | 0.65 | 4.35 | 5.9 | 10.5 | 6.5 | 1.8 | 1.1 |
| | | type air flow | | | | | | | | | |
| Example 2 | A | Collision | Air flow | No | 0.75 | 4.35 | 5.9 | 10.8 | 6.5 | 1.8 | 1.1 |
| | | type air flow | | | | | | | | | |
| Example 3 | A | Collision | Air flow | No | 0.75 | 3.48 | 5.8 | 10.9 | 6.5 | 1.9 | 1.1 |
| | | type air flow | | | | | | | | | |
| Example 4 | A | Collision | Air flow | No | 0.65 | 5 | 6.0 | 12.2 | 6.5 | 2.0 | 1.1 |
| | | type air flow | | | | | | | | | |
| Example 5 | A | Collision | Air flow | No | 0.65 | 7 | 6.2 | 11.7 | 6.5 | 1.9 | 1.1 |
| | | type air flow | | | | | | | | | |
| Example 6 | A | Collision | Air flow | No | 0.65 | 7 | 6.4 | 12.0 | 7.1 | 1.9 | 1.1 |
| | | type air flow | | | | | | | | | |
| Example 7 | B | Collision | Air flow | No | 0.65 | 7 | 4.9 | 8.6 | 5.0 | 1.8 | 1.0 |
| | | type air flow | | | | | | | | | |
| Example 8 | B | Collision | Air flow | No | 0.65 | 10 | 5.7 | 11.3 | 6.0 | 2.0 | 1.0 |
| | | type air flow | | | | | | | | | |
| Example 9 | B | Collision | Air flow | Air flow | 0.65 | 10 | 4.8 | 7.9 | 5.0 | 1.6 | 1.0 |
| | | type air flow | | | | | | | | | |
| Example 10 | B | Collision | Air flow | Air flow | 0.65 | 7 | 4.7 | 9.2 | 5.0 | 2.0 | 1.1 |
| | | type air flow | | | | | | | | | |
| Example 11 | A | Collision | Air flow | Air flow | 0.65 | 7 | 5.2 | 8.0 | 6.0 | 1.5 | 1.1 |
| | | type air flow | | | | | | | | | |
| Comparative | A | Mechanical | Yes | No | 7800 | 26 | 22.2 | 51.6 | 20.2 | 2.3 | 0.9 |
| Example 1 | | | | | | | | | | | |
| Comparative | A | Mechanical | Yes | No | 7800 | 23 | 20.5 | 54.3 | 18.5 | 2.7 | 0.9 |
| Example 2 | | | | | | | | | | | |
| Comparative | A | Mechanical | No | No | 8000 | 10 | 15.6 | 178.5 | 13.1 | 11.4 | 0.8 |
| Example 3 | | | | | | | | | | | |
| Comparative | A | Wet | No | No | 2124 | 4 | — | — | — | — | — |
| Example 4 | | | | | | | | | | | |
| Comparative | A | Wet | No | No | 150 | 0.4 | — | — | — | — | — |
| Example 5 | | | | | | | | | | | |

1. A method for producing a liquid crystal polymer particle, comprising a step of pulversizing a liquid crystal polymer with a jet mill to thereby obtain a liquid crystal polymer particle in which cumulative distribution 50% size D₅₀ is 7.0 μm or less and 95% size D₉₅ is 15.0 μm or less in a particle size distribution.

2. The method for producing a liquid crystal polymer particle according to claim 1, wherein a ratio of a mode size Dₚ to D₅₀ in the particle size distribution of the liquid crystal polymer particle is 0.7 or more and 1.3 or less.

3. The method for producing a liquid crystal polymer particle according to claim 1, wherein the pulversizing is performed by collision to a collision member in air flow.

4. The method for producing a liquid crystal polymer particle according to claim 1, further comprising a step of classifying the liquid crystal polymer particle before or after the pulversizing.

5. The method for producing a liquid crystal polymer particle according to claim 1, wherein the liquid crystal polymer particle contains a hydroxycarboxylic acid-derived constituent unit (I), a diol compound-derived constituent unit (II), and a dicarboxylic acid-derived constituent unit (III).

6. The method for producing a liquid crystal polymer particle according to claim 5, wherein the hydroxycarboxylic acid-derived constituent unit (I) is a 6-hydroxy-2-naphthoic acid-derived constituent unit.

7. The method for producing a liquid crystal polymer particle according to claim 5, wherein a compositional ratio of the constituent unit (I) based on the total constituent unit of the liquid crystal polymer particle is 40% by mol or more and 80% by mol or less.
